(19) United States
(12) Patent Application Publication
(10) Pub. No.: US 2023/0014652 A1
(43) Pub. Date: Jan. 19, 2023

(54) MILL SENSOR AND METHOD OF MONITORING A MILL

(71) Applicant: BRADKEN RESOURCES PTY LIMITED, New South Wales (AU)

(72) Inventors: Reece ATTWOOD, New South Wales (AU); Craig Frank FAULKNER, Queensland (AU); Wei CHEN, New South Wales (AU); Brad John DRINKWATER, New South Wales (AU)

(73) Assignee: BRADKEN RESOURCES PTY LIMITED, New South Wales (AU)

(21) Appl. No.: 17/757,021

(22) PCT Filed: Dec. 9, 2020
(86) PCT No.: PCT/AU2020/051349

§ 371 Date: Jun. 8, 2022

(30) Foreign Application Priority Data
Dec. 9, 2019 (AU) 2019904656

(51) Int. Cl. B02C 17/18; B02C 17/22; G01H 1/00

(52) U.S. Cl. CPC B02C 17/1805; B02C 17/22; G01H 1/003; B02C 2210/01

(57) ABSTRACT

Disclosed herein is a mill liner assembly for a grinding mill, comprising: a mill liner which comprises a wear surface and an opposite inner surface that is arranged in use to be mounted in opposed relation to an interior surface of a shell of the grinding mill, a liner sensor which is embedded within the mill liner; and a control or power arrangement configured to control or power the liner sensor, the control or power arrangement being also embedded in the mill liner.

### CROSS-REFERENCE TO RELATED APPLICATIONS

This application is a U.S. National Stage Application under 35 USC § 371 of International Application No. PCT/AU2020/051349, filed Dec. 9, 2020, which claims the priority of Australian Application No. 2019904656, filed Dec. 9, 2019, the entire contents of each priority application of which is incorporated herein by reference.

### FIELD OF THE DISCLOSURE

Embodiments relate to a sensor and other components for a grinding mill, in particular to measure changes in configuration of the mill and to a method of monitoring a mill, in particular, a method of monitoring the operating conditions and changes to configuration of a mill.

### BACKGROUND OF THE DISCLOSURE

Grinding mills are used to break materials into smaller pieces. An economically significant use of mills is in the mining industry where they are used to grind ore into smaller pieces, needed for more efficient further processing of the ore.

Examples of grinding mills used include autogenous mills where a rotating drum forms a cascade of ore pieces of varying sizes which, on impact with each other, results in a grinding action, producing smaller sized rocks. Semi-autogenous mills add balls made from steel or other hard materials to the ore to assist in the grinding process.

As the drum of the mill rotates, the material to be reduced (referred to as the “charge”) forms a flowing cascade within the drum. The leading edge of the charge prior to falling is referred to as the “shoulder” whereas the trailing edge of the charge, or the material which has recently fallen, is referred to as the “toe”.

Establishing the optimum grinding for a particular mill may be a complex process which depends on a number of factors. One of the main factors is the speed of the rotation of the drum. If the speed is too fast, centripetal forces will carry the shoulder of the charge too far up the wall of the drum so that when the cascade falls, it falls directly onto the drum. The speed is too slow, the height of the cascade is reduced, therefore reducing the effectiveness of the mill.

Since the inner surface of the drum is subject to significant pounding from the falling cascade of the charge, the drum is provided with replaceable liners which protect the cylindrical shell of the drum and form replaceable wear parts that extend the life of the mill. However, these replaceable liners form a significant operating cost to the mill and replacement disrupts the operation of the mill, reducing output.

The hard-wearing nature of the materials required for the shell and the liners means that it is not possible for an operator to view the inside of the drum during operation of the mill, making it difficult for the operator to improve operating conditions for the mill.

It is to be understood that, if any prior art publication is referred to herein, such reference does not constitute an admission that the publication forms a part of the common general knowledge in the art, in Australia or any other country.

### SUMMARY OF THE DISCLOSURE

An embodiment extends to a mill liner for a grinding mill, the liner comprising a wear surface and an opposite inner surface that is arranged in use to be mounted in opposed relation to an interior surface of a shell of the grinding mill, and a vibration sensor disposed within the mill liner, the vibration sensor sensing vibration of the liner in use of the mill.

Measurement of vibration may be used to provide information of mill operating characteristics such as charge toe positions which may be used to improve operation efficiency of the mill. An advantage of the present arrangement is that by disposing the vibration sensor in liner, more accurate reading of vibration may be obtained as compared to measurements of the vibration at locations remote from the liner, such as at the shell. In one form, the data capture from the vibration sensors may include mill rotation angle, amplitude and frequency of the embedded sensor.

The mill liner may further comprise a wear sensor to sense wear of the wear surface of the liner during use.

The wear sensor and the vibration sensor may be connected to form a sensor unit.

The wear sensor may wear together with the liner.

The wear sensor may comprise a ladder resistor.

The mill liner may further comprise means to transmit information relating to sensed vibration and/or wear of the mill liner to a location remote from the mill.

The means to transmit information may comprise an antenna wherein the antenna is attachable to the sensor unit through the opposed inner surface of the liner. Installation of the antenna may facilitate switching on of the sensor.

The vibration sensor may include at least one accelerometer. In one form, the vibration sensor may be a 2 or 3 axis accelerometer. In one form, the vibration sensor may be a 6 axis accelerometer (being a 3-axis accelerometer and a 3-axis gyroscope). Such an arrangement also allows for rotational measurement at the mill liner. In yet a further form, the accelerometer may be 9-axis (being 3-axis accelerometer, a 3 axis gyroscope, and a 3-axis compass)

The sensor unit is disposed in a void formed in the mill liner. The void may be precast in the liner. The sensor unit may be encapsulated by the void and a seal. The seal may be made from epoxy. Where the mill liner includes an antenna, the antenna may be fitted from the opposite inner surface. The antenna may be fitted after installation of the sensor unit. The antenna may be installed via access ports to the void, wherein the access port is accessible via a frangible portion of the inner surface.

In a particular form, the sensors may be accessible via its inner surface through the shell of the mill and in particular, through preformed holes formed in the shell. In use, many mill shells include “knockout” holes in the shell which are designed to receive a suitable shaped implement to push worn liners (which have been unbolted from the shell) into the mill for collection and replacement. Utilising these holes (by aligning the position to the sensor assembly on the liner to correspond to the knockout holes when installed) provides a convenient access point to the sensor and fitment of the antenna once installed. A further advantage is that disposing the antenna through the knockout holes allows clear RF transmission of the signals from the sensor.

A further embodiment extends to a liner sensor for use with a liner disposed on an inner surface of a drum of a grinding mill, the liner sensor comprising a vibration sensor to sense vibration of a liner in use of the mill and a wear sensor to sense wear of a wear surface of the liner during use.

The vibration sensor and the wear sensor may be provided as portions of a structural unit. The structural unit may be used to attach the liner to the drum. The structural unit may be a bolt.

The wear sensor may wear together with the liner.

The wear sensor may comprise a ladder resistor and/or the vibration sensor may comprise an accelerometer.

The liner sensor may further comprise a thermometer and/or a battery capacity metre.

The liner sensor may further comprise a wireless communication module. The wireless communication module may be adapted to communicate via LTE and/or LoRa.

The liner sensor may further comprise a housing wherein the vibration sensor is housed in the housing.

A further embodiment extends to a fastener for fastening a liner to an inner surface of a shell of the mill drum, the fastener comprising a liner sensor according to any form described above.

In one form, the fastener comprises a liner sensor comprising a vibration sensor and a wear sensor. In one form, the fastener comprising a shank and a housing connectable to the shank wherein the shank incorporates the wear detector and the housing accommodates the vibration sensor.

A connection between the housing and the shank may be flexible. The connection may be vulcanized and may be made from rubber.

A further embodiment extends to a grinding mill comprising a shell and a liner, the liner including a wear surface and a opposite inner surface disposed on an interior surface of the shell, the mill further comprising a liner sensor embedded in the liner, the liner sensor comprising a vibration sensor to sense vibration of the liner in use of the mill.

The grinding mill may further comprise a wear sensor to sense wear of a wear surface of the liner during use of the mill. The wear sensor may be embedded in the liner. The wear sensor may be connected to the vibration sensor or may be provided separate thereto.

The grinding mill may further comprise a plurality of liners, each liner having a corresponding vibration sensor and wear sensor.

The grinding mill may further comprise means to transmit information relating to sensed vibration and/or wear of the mill liner to a location remote from the mill.

The means to transmit information may be connected to the vibration sensor and may be disposed through an outer surface of the shell.

A further embodiment extends to a method of monitoring a grinding mill, the grinding mill comprising a shell and a liner, the liner including a wear surface and a opposite inner surface disposed on an interior surface of the shell, the mill further comprising a liner sensor embedded in the liner, the liner sensor comprising a vibration sensor to sense vibration of the liner in use of the mil, the method comprising:
collating measurements from the vibration sensor over a predetermined period; and
establishing a profile for the mill based on the collated measurements.

A further embodiment relates to a method of monitoring a grinding mill, the grinding mill comprising a shell and a liner, the liner including a wear surface and a opposite inner surface disposed on an interior surface of the shell, the mill further comprising a liner sensor comprising a vibration sensor to sense vibration of the liner in use of the mil, and a wear sensor for sensing wear of the wear surface, the method further comprising: collating measurements from the vibration sensor over a predetermined period; collating measurements from the wear sensor over the predetermined period establishing a profile for the mill based on the collated measurements.

The mill may comprise a plurality of liner sensors and/or wear sensors located at disparate locations in the mill and the method may further comprise collating measurements from the plurality of vibration sensors and/or wear sensors together with location information relating to the location of each vibration sensor and/or wear detector.

The method may further comprise the step of changing at least one operating parameter of the mill and determining changes to the collated measurements related to the changed parameter.

The changed parameter may be one or more of: a size of the charge; aggregate particle size; rotational speed of the drum; and slurry input rates to the mill.

The mill may further comprise a rotational sensor to determine a rotational orientation of the drum measured as an angle, the method may further comprise the step of collating angle measurements, and wherein the profile of the mill is based on the angle measurements. These rotational measurements may be obtained from using a 6-axis accelerometer as the vibration sensor

The method may further comprise collating measurements from the vibration sensor with angle measurements.

The method may further comprise establishing vibration characteristics at the liner such as amplitude and frequency.

A further embodiment extends to a mill liner assembly for a grinding mill, comprising: a mill liner which comprises a wear surface and an opposite inner surface that is arranged in use to be mounted in opposed relation to an interior surface of a shell of the grinding mill; a liner sensor which is embedded within the mill liner; and a control or power arrangement configured to control or power the liner sensor, the control or power arrangement being also embedded in the mill liner.

In use, the control or power arrangement may be activatable through an aperture provided in a shell of the grinding mill.

The aperture may be separate from a mounting aperture provided for receiving a fastener to fasten the mill liner assembly to the grinding mill.

The liner sensor may include a wear sensing arrangement configured to measure wear in the wear surface, a vibration sensor configured to sense vibration of the mill liner in use in the grinding mill, or both.

The liner sensor may comprise at least one active sensor component.

The at least one active sensor component may be, or may be part of, an interrogator component configured to provide an interrogation signal.

The mill liner or a responsive component embedded in the mill liner may be adapted to interact with the interrogation signal to generate a response signal.

The at least one active sensor component may be, or may be part of a responsive component configured to interact with an interrogation signal and provide a response signal.

The power or control arrangement may be located in a cavity formed in the mill liner, or located in a plug adapted to substantially seal the cavity.

A further embodiments extends to a mill liner assembly for a grinding mill, comprising: a mill liner which comprises a wear surface and an opposite inner surface that is arranged in use to be mounted in opposed relation to an interior surface of a shell of the grinding mill; and a vibration sensor embedded within the miller liner, the vibration sensor sensing vibration of the liner in use of the mill liner in the grinding mill.

A further embodiment extends to a mill liner assembly for a grinding mill. The assembly comprises: a mill liner which comprises a wear surface and an opposite inner surface that is arranged in use to be mounted in opposed relation to an interior surface of a shell of the grinding mill; and a wear sensing arrangement for sensing wear of the wear surface during use, the sensor arrangement comprising a first component adapted to provide an interrogation signal, the first component being embedded in the liner. The wear sensing arrangement further comprises a responsive component which is adapted to interact with the interrogation signal to provide a response signal, wherein the responsive component is also embedded in the liner.

Another embodiment extends to a mill liner assembly for a grinding mill, comprising: a mill liner which comprises a wear surface and an opposite inner surface that is arranged in use to be mounted in opposed relation to an interior surface of a shell of the grinding mill; and a wear sensing arrangement for sensing wear of the wear surface during use, the sensor arrangement comprising a first component adapted to provide an interrogation signal, the interrogation component being embedded in the liner. The wear sensing arrangement comprises a power or control arrangement configured to control operation the first component.

A response signal acquired in response to the interrogation signal may provide two-dimensional data in relation to the wear surface.

The power or control arrangement may be embedded in the mill liner, or in a plug configured to at least partially close a cavity in the liner in which the first component is embedded.

The mill liner assembly may further comprise a vibration sensor disposed within the miller liner, the vibration sensor sensing vibration of the liner in use of the mill.

The interrogation component and the vibration sensor may be connected to form a sensor unit.

The responsive component may wear together with the mill liner.

The responsive component may comprise one of: a ladder resistor, an ultrasonic probe, sacrificial dielectric or optical components.

The mill liner assembly may further comprise means to transmit information relating to sensed vibration and/or wear of the mill liner to a location remote from the mill.

The means to transmit information may comprise an antenna wherein the antenna is attachable to the wear sensing arrangement through the opposed inner surface of the liner.

The means to transmit information may be a transceiver device.

The means to transmit information may be provided in an aperture provided in the shell of the grinding mill.

The transceiver device may be in use configured to provide an activation signal to the wear sensing arrangement.

Where provided, the vibration sensor cab include at least one accelerometer.

The wear sensing arrangement may be disposed in a void formed in the mill liner.

The sensor or sensing arrangement may be embedded so that it is positioned within an envelope of the liner and/or fully encapsulated in the liner.

Components coupled to the sensor or sensing arrangement may be embedded so that they are positioned within an envelope of the liner, and/or fully encapsulated in the liner.

In other arrangements, the sensor or sensing arrangement may have all, or at least the major of, the components mounted to, or integrated with the mill liner. In this way the liner and sensor may be provided as an integrated assembly that can be assembled offsite and transported as an integrated component to site. In some forms, the mill liner itself provides the major of the protection for the sensor componentry. This approach simplifies manufacture, transport and onsite installation of the liner and sensor.

In an aspect, embodiments provide a liner sensor for use with a liner disposed on an inner surface of a drum of a grinding mill, the liner sensor comprising a vibration sensor to sense vibration of a liner in use of the mill and a wear sensing arrangement to sense wear of a wear surface of the liner during use, the wear sensing arrangement including at least one array of transducers.

The vibration sensor and the wear sensing arrangement may be provided as portions of a structural unit.

The wear sensing arrangement may include a wear part that wears together with the liner.

The vibration sensor may comprise an accelerometer.

The liner sensor may further include a thermometer and/or a battery capacity metre.

The liner sensor may further comprise a wireless communication module.

The liner sensor may further comprise a housing wherein the vibration sensor is housed in the housing.

In an aspect, embodiments extend to a grinding mill comprising a shell and one or a plurality of the liner assembly mentioned above.

In another aspect, embodiments extend to a method of monitoring a grinding mill, the grinding mill comprising a shell and one or more liner assemblies mentioned above, the liner sensor further comprising a vibration sensor to sense vibration of the liner in use of the mil. The method comprises: collating measurements from the vibration sensor over a predetermined period; and establishing a profile for the mill based on the collated measurements.In another aspect, embodiments extend to a method of monitoring a grinding mill, the grinding mill comprising a shell and one or more liner assemblies mentioned above, each liner assembly comprising a vibration sensor to sense vibration of the liner assembly in use of the mil, the method comprising: collating measurements from the vibration sensor over a predetermined period; collating measurements from the wear sensor over the predetermined period establishing a profile for the mill based on the collated measurements.

In one form, the mill comprises a plurality of vibration sensors and/or wear sensing arrangements located at disparate locations in the mill, and the method further comprises collating measurements from the plurality of vibration sensors and/or wear sensors together with location information relating to the location of each vibration sensor and/or wear sensing arrangement.

In one form, the method further comprises the step of changing at least one operating parameter of the mill and determining changes to the collated measurements related to the changed parameter.

The changed parameter may be one or more of: a size of the charge; aggregate particle size; rotational speed of the drum.

The mill may further comprise a rotational sensor to determine a rotational orientation of the drum measured as an angle, the method further comprising the step of collating angle measurements, and wherein the profile of the mill is based on the angle measurements.

The method may further comprise collating measurements from the vibration sensor with angle measurements.

In another aspect, embodiments comprise a method of transporting a mill liner for a grinding mill, the method comprising: providing a liner sensor for use with the grinding mill; embedding the liner sensor within a mill liner, the mill liner having a wear surface and an opposite inner surface that is arranged in use to be mounted in opposed relation to an interior surface of a shell of the grinding mill; and transporting the mill liner with the liner sensor embedded therein.

In another aspect, embodiments comprise a method of transporting a mill liner assembly for a grinding mill, the method comprising: providing a liner sensor for use with the grinding mill; integrating the liner sensor with a mill liner, the mill liner having a wear surface and an opposite inner surface that is arranged in use to be mounted in opposed relation to an interior surface of a shell of the grinding mill; and transporting the mill liner with the liner sensor as an integrated assembly

### BRIEF DESCRIPTION OF THE FIGURES

Embodiments are herein described, with reference to the accompanying drawings in which:

FIG. 1 is a perspective view of a mill liner according to an embodiment and a removal machine;

FIG. 2 is a perspective view of a grinding mill with a plurality of liners of embodiments;

FIG. 3a is a plan view of an embodiment of a coupling component of a mill liner;

FIG. 3b is a cross-sectional view of the mill liner of FIG. 2 along the line D-D.

FIG. 4a is a plan view of an embodiment of a coupling component of a mill liner.

FIG. 4b is a cross-sectional view of the mill liner of FIG. 2 along the line B-B.

FIG. 5 is a schematic view of a liner sensor according to an embodiment;

FIG. 6 is a cross-sectional view of a portion of a liner showing the liner sensor of FIG. 5 in situ;

FIG. 7 is a schematic cross-sectional view of a fastener according to an embodiment;

FIG. 8 shows an example circuit diagram for a wear sensor for use with embodiments;

FIG. 9 shows a system for carrying out a method of monitoring a grinding mill according to an embodiment;

FIG. 10 shows a method of monitoring a grinding mill according to an embodiment;

FIG. 11 shows a liner sensor in accordance with another embodiment, including a wear part embedded in the liner and an interrogation component embedded in a plug;

FIG. 12 shows a liner assembly in accordance with a further embodiment, where the liner sensor includes a wear part and an interrogation component, both embedded in a liner;

FIG. 13 shows a liner assembly in accordance with a further embodiment, having an ultrasonic arrangement embedded in a liner;

FIG. 14 shows a variant of the liner sensor assembly shown in FIG. 12, provided without an antenna for activation of the embedded sensor;

FIG. 15 shows a further variant of the liner sensor assembly shown in FIG. 12, provided without an antenna for activation of the embedded sensor;

FIG. 16 shows another embodiment of a liner senor assembly, where an embedded power or control device provides a seal or closure for the liner cavity in which the liner sensor is embedded; and

FIG. 17 depicts an arrangement where a control device supplies an energy to a plurality of active sensor elements.

### DETAILED DESCRIPTION OF THE DISCLOSURE

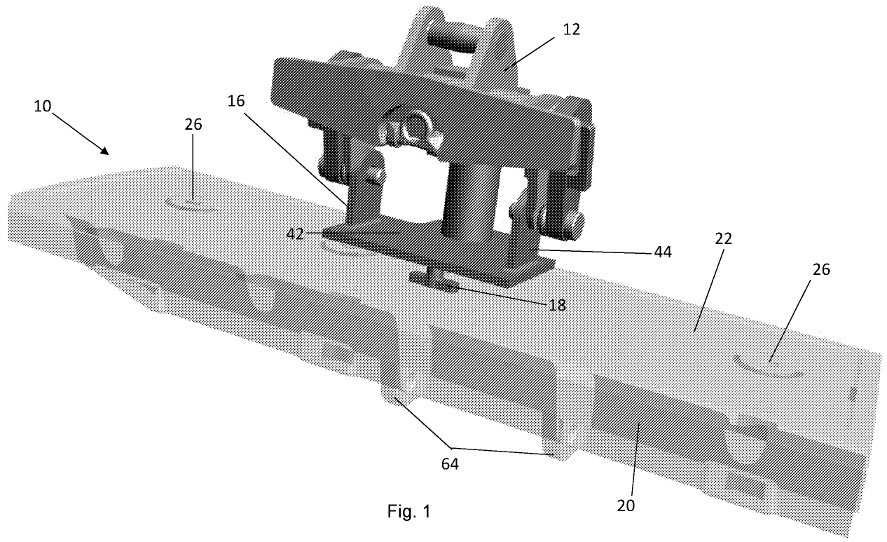

FIG. 1 illustrates a mill liner 10 according to an embodiment. The mill liner 10 is installed and removed from a mill with the use of a replacement machine 12. The mill liner 10 includes a coupling component 14 (not shown in FIG. 1) that forms part of a coupling to connect the mill liner 10 to a coupling tool 16 releasably mountable to a working arm of the machine 12.

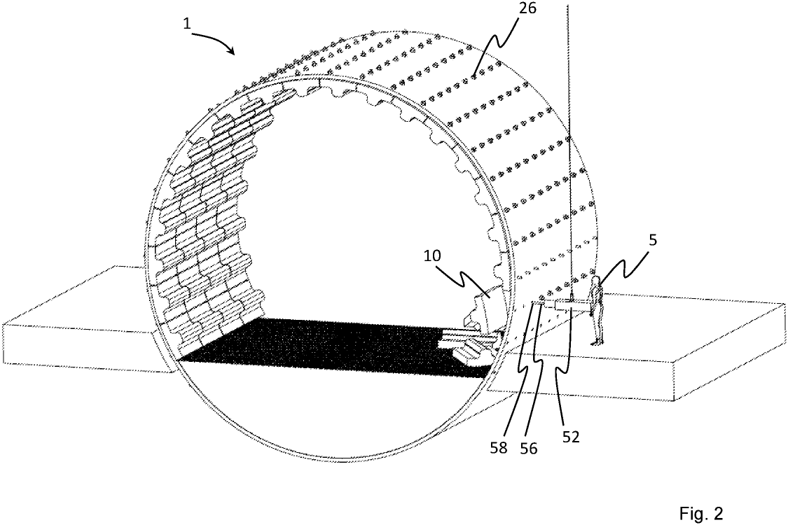

The mill liner 10 includes a wear surface 20 and an opposite inner surface 22. When installed in the grinding mill 1 (FIG. 2), the inner surface 22 is in opposed relation and abuts against an interior surface 24 of the grinding mill when the mill liner 10 is mounted to the interior surface 24 of the grinding mill. In the illustrated form, the mill liner 10 also includes a fixing arrangement 26 for removably mounting the liner 10 to interior surface 24 of the grinding mill. The coupling component 14 may be accessible via the inner surface 22 and/or the wear surface 20. In alternative embodiments, the mill liner may not be directly mounted to the interior surface of the grinding mill and may be mounted indirectly to the interior surface of the grinding mill via another liner.

Typically, mill liners 10 are releasably mounted to the interior surface 24 of the grinding mill 1 via the fixing arrangement 26. When mounted, the inner surface 22 of the mill liner 10 is in opposing face relation with the interior surface 24 of the grinding mill 1 (FIG. 2) and abuts against the interior surface 24 of the grinding mill 1. The fixing arrangement 26 is in the form of holes that extend through the mill liner and a wall of the grinding mill (which includes the interior surface). Mechanical fasteners 26 extend through the aligned holes and are fastenable and releasable from exterior the grinding mill. It is understood that the fixing arrangement may be in another suitable form and is not required to extend all the way through the mill liner.

In general, replacement of the mill liners requires removal of worn mill liners and installation of new mill liners.

FIG. 2 illustrates one of the operators 5 removing the mill liner 10 from the interior surface 24 of the grinding mill 1. The operator 5 releases the fixing arrangement 26 using a liner removal tool 52. In the illustrated embodiment, the fixing arrangement 26 is in the form of mechanical fasteners 26 mounting the mill liner 10 to the wall of the grinding mill 1. The mechanical fasteners 26 extend through aligned holes in the mill liner 10 and the wall of the grinding mill 1. The mechanically fasteners 26 generally include at least two components that are in threaded engagement to clamp the mill liner 10 to the grinding mill wall 1. Each mechanical fastener 26 includes a drive end 52 that is engageable with an end of the liner removal tool 52. Rotation of the drive end 52 either fasteners or unfastens the mechanical fastener depending on the direction of rotation.

The liner removal tool 52 includes an elongate shaft 56 including the end 58 and the elongate shaft 56 is rotatable. The end 58 of the machine engages with the drive end 52 and rotates to unfasten the mechanical fastener 26. Once the mechanical fastener 26 is removed from the hole, the elongate shaft 56 of the liner removal tool 52 is operable to extend through the hole of the grinding mill wall 1 and knock-in the mill liner 10.

In some form, the grinding mill wall 1 may include additional holes which are not arranged to receive the fasteners, but which are utilised for knocking in the miller liners 10

FIG. 2 shows the mill liner 10 just after it has been removed from the interior surface 24 of the grinding mill 1 and as it is falling under gravity to the ground within the grinding mill 1. The tendency is for the mill liner to fall with the inner surface 22 facing up, and thus the inner surface 22 is accessible.

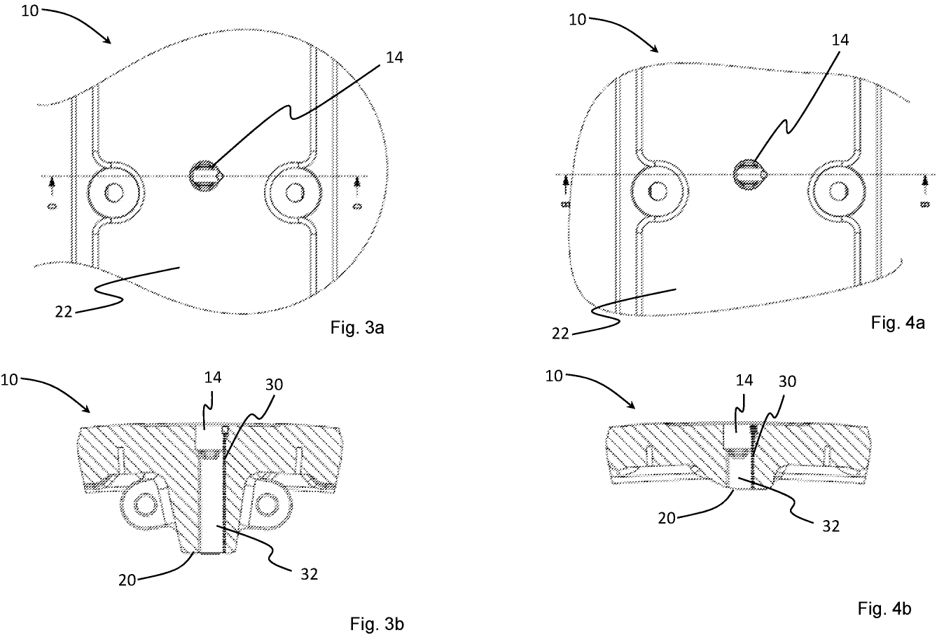

In embodiments, a liner sensor 30 is disposed in the cavity that forms the coupling component 14. FIGS. 3a to 4b illustrate such an arrangement.

In the illustrated embodiment, the liner sensor 30 is disposed within a coupling component of a liner. The liner sensor 30 is fixed on an internal surface of cavity 14 and includes a wear sensor 32 which extends into the cavity 14. The cavity 14 is accessible for coupling to a coupling tool with the wear indicator disposed in cavity 14. The cavity 14 may extend the full width of a mill liner 10, i.e., extend from the inner surface 22 to the wear surface 20. The wear sensor 32 of the liner sensor may extend along the full length of the cavity 14, terminating at the wear surface 20 of the mill liner 10.

The wear sensor 32 is designed to reduce in length as the wear surface 20 is worn down. As best shown in FIGS. 4a and 4b, the more degradation the wear surface 20 experiences, the less remaining material of the wear sensor 32.

Further arrangements of mill liners which may be suitable for use with embodiments are disclosed in PCT/AU2019/050864, the contents of which are hereby incorporated by reference.

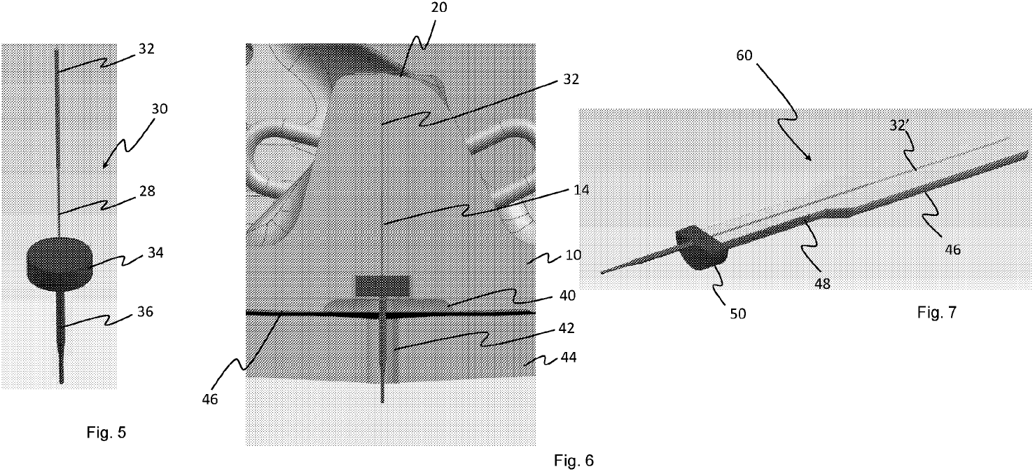

FIG. 5 is a schematic view of a liner sensor 30 according to an embodiment. The liner sensor 30 includes a wear sensor 32 attached by a wire 28 to a housing 34. The housing 34 accommodates a vibration sensor which, in this embodiment, is a collection of accelerometers which measure the vibration of the liner 10 in at least two spatial axes. In this way, the vibration sensor is able to detect the frequency and amplitude of vibration at the housing. The vibration sensor preferably measures not only vibration in these two dimensions but may allow measurement over 6 or 9 axes, such as may include a 3 axis accelerometer, a 3 axis gyroscope (to allow measurement of vibration) and in one form a 3 axis compass. Although the vibration sensor of this embodiment uses accelerometers, it is to be realised that other forms of vibration sensors may be used instead. In an alternative embodiment, transducers may be used to convert migration into electrical signals.

The liner sensor 30 further comprises an antenna 36 attached to the housing 34. The housing 34 accommodates a wireless transmitter which attaches to the antenna 36 and uses this to transmit information wirelessly. The wear sensor 32 is attached to the vibration sensor to form a sensor unit.

FIG. 6 illustrates the liner sensor 30 installed in liner 10. As illustrated, the liner sensor 30 is disposed within the cavity 14 with the wear sensor 32 extending to the outermost portion of the liner defining the wear surface 20. In the embodiment of FIG. 6, the cavity 14 is pre-formed in the liner 20 and is sealed in that cavity as part of the manufacture of the liner 20. As such the liner 10 is delivered on site with the sensor 30 embedded therein. In the particular form as disclosed, the sensor 30 is arranged to extend to the inner surface 47 and aligns with a knockout hole 42 in the mill liner shell 44.

A plug 40 closes the portion of the cavity 14 closest to the inner surface 47 of the liner 10. Knockout hole 42 extends through the shell 44 of the mill and the antenna 36 is accommodated within the cavity 42 and extends through the plug 40. In use, the antenna 36 may be fitted after installation of the liner on the mill wall via access through the knockout hole 42. The antenna may then extend back through the hole to allow better transmission of an RF signal from the sensor. The installation of the antenna may cause the sensors contained within the housing 34 to turn on.

Thehousing 34 which accommodates the vibration sensor is therefore encased, disposed or embedded within the liner 10. It may be advantageous for certain embodiments that the liner completely surrounds the housing (with the exception of the extension of the cavity 14 accommodating the wear sensor and the cavity accommodating the antenna 36) and the housing accommodates the vibration sensor so that vibrations in the liner are more directly transmitted to the vibration sensor.

In FIG. 6, the wear sensor 32 which is embedded in the liner 20 is a wear part or probe which is subject to wear. Here the wear sensor 32 may be considered a responsive component, in that it provides a return signal conveying information which may be transmitted for further processing or monitoring. The information conveyed is in relation to the amount of wear in the liner. In this embodiment, the wear sensor 32 is configured to interact with an interrogating signal from an interrogating component, to provide the return signal. The interrogating component may include a component which emits or generates the interrogating signal, or a component which provides energy that acts as the interrogating signal.

The vibration sensor, which provides a return signal in response to sensing a vibration, may also be considered to be a responsive sensor component. However, rather than interacting with an interrogation signal, it provides a return signal in response to the detection of vibration.

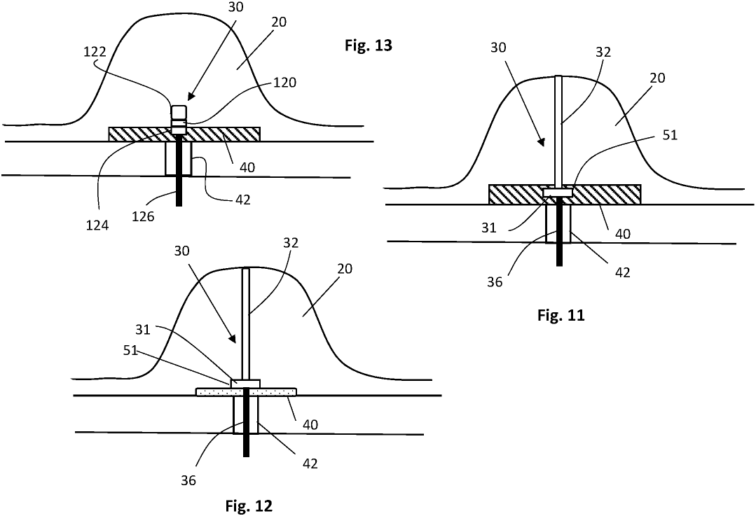

As shown in FIG. 6 and FIG. 12, the interrogator component(s) may be embedded, enclosed, or encased in the liner 20. It may be provided in a housing 51 which further houses other sensors such as vibration sensors or acoustic sensors, if these are provided. Alternatively, the interrogator component(s) 31 may be at least partially seated in a plug to seal the cavity in which the wear part 32 is located (see FIG. 11).

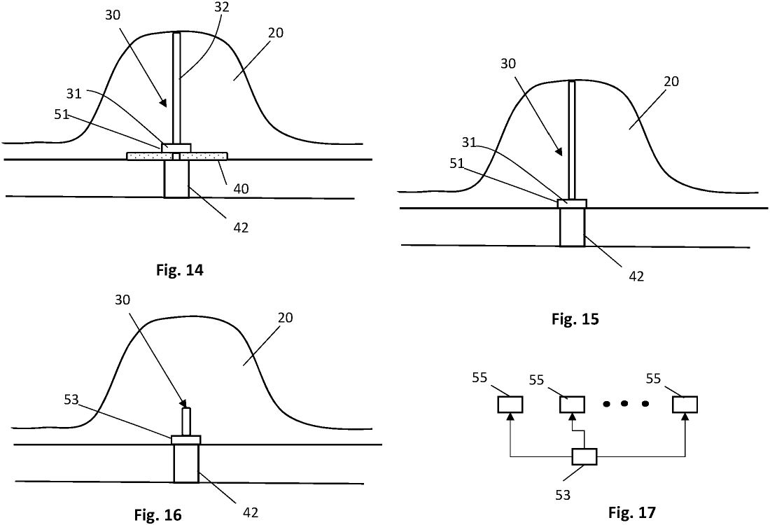

In the depicted embodiments, an antenna is provided through the knockout hole 42 to enable activation of the sensors. However this antenna is optional. For example, FIG. 14 and FIG. 15 show alternative embodiments, where the activation of the sensor components may be made via the knockout hole 42, but without an antenna being present. This activation therefore may be a direct activation through the knockout hole 42, e.g. to switch on the sensor components. The power or control componentry coupled to the sensors may further be configured so as to accept wireless charging, which may also be done through the hole 42. The sensor componentry and related componentry coupled to the sensor componentry ― such as that comprising components for one or more of power, control, or communication arrangements ― may embedded such that in use they will not be located in and /or require to be mounted to the shell.

FIG. 15 further shows an example in which the housing 51 is configured to also function as a seal to close the cavity in which the wear sensor 32 is embedded. In an alternative embodiment, an embedded power or control device 53 may instead with its housing or casing provide a seal or closure function to close the cavity in the liner 20 in which the liner sensor 30 is embedded (see FIG. 16).

The liner sensor 30, including the interrogator 31 and the wear part 32 are embedded in the liner 20 and form part of the liner assembly to be transported together. The interrogator 31 may be externally powered or it is preferably self-powered (e.g., having a battery). Where provided, the control arrangement to control the liner sensor 30, or the power arrangement to power the liner sensor 30, or both, may also be embedded in the liner 20.

It will be appreciated that different types of wear part 32 may be provided. For example, the wear part 32 may include sacrificial material (e.g., a wear probe) whose length is being measured by the interrogating signal. It may house or have attached thereto sacrificial circuit componentry, optical mirrors, semiconducting components, etc. Interrogating signals or waves from the interrogating component are provided to the responsive component, which may be expected to provide signals of different characteristics, such as of different phases, strengths, timing, frequencies, etc., depending on the amount of wear in the liner, causing a corresponding “wear” in the wear sensor.

In some cases, the interrogating signal directly interrogates the liner and does not require any wear part 32 or sacrificial material. The return signal is generated by interaction between the liner and the interrogating signal, such as but not limited to, by echoing, reflection, or attenuation of signal power levels. In these embodiments, again, where provided, the control arrangement, or the power arrangement, or both, may be embedded in the liner 20.

In the disclosed embodiments, the interrogating signals may be generated from a plurality of interrogators, such as transducers. The interrogators may be arranged in an array or in a matrix, and disposed about the mill liner 20, so that information regarding various parts of the same mill liner 20 may be obtained. For example, see FIG. 17, which conceptually depicts an arrangement where a control device 53 provides energisation to a plurality of interrogating components (e.g. transducers) 55.

Selective or sequenced energisation of the interrogating components may be used to generate differently directed interrogating signals. In particular, when an array of interrogating components are activated together ― whether simultaneously or within an energisation sequence ― they may be used to elicit two-dimensional response signals. A response signal which is of at least two dimensions provides two-dimensional data in relation to the wear surface.

For example, phased array scanning may be used to scan a plane or a slice of the liner 20. In one implementation, conceptually shown in FIG. 13, the interrogating components will include an oscillator 120 and at least one array of ultrasonic transducers 122, where the oscillator 120 supplies wave signals to the transducers 122. The phased array 122 is in connection or in communication with a controller 124 which controls the operation of the transducers, for example, to provide a delay between the activation of successive transducers or to simultaneously activate at least a subset of the transducers. The oscillator 120 is wirelessly activated using an antenna 126 located in the knockout hole 42, but it may instead be directly activated, in which case an antenna will not be required for the activation. The delay may be programmable to change the phase angle. In further embodiments, dynamic phased arrays may instead be used, which could obtain more information regarding the mill liner. Corresponding componentry to cooperate with the dynamic phased arrays would also be included in those embodiments.

In FIG. 13, the controller 124 which controls the activation of the transducers is embedded in the plug 40. However, it may instead be embedded within the mill liner.

Making use of imaging sensors may provide the technical advantage of acquiring an image of the liner 20, rather than just an estimated liner thickness. By acquiring the liner image, it is possible to ascertain information regarding the quality of the liner generally -such as whether there has been a formation of cracks or other defects in the liner, and information regarding the location and size of the cracks or defects. Depending on the imaging sensors used it is further possible to adjust the scan orientation so that a more complete picture of the liner may be acquired. In embodiments making use of phased array ultrasounds, the controlled delay for a phased array ultrasound may be modified to adjust the scan angle. The oscillator may further be activated to different extents to generate interrogating beams of different strengths.

Where applicable, these generalised embodiment or embodiments may include various features described with reference to FIG. 6. For example, as in the case shown in FIG. 6, both the responsive component and the interrogating component are embedded within the liner 20, and further sealed or substantially sealed by a cover or plug 40. As another example, as in the embodiment shown in FIG. 6, a transceiver device, such as an antenna may be provided through the knockout hole to activate the interrogating component. The antenna may be a radio frequency (RF) antenna.

The sensor components, which may be interrogating components, response components, or combined interrogation and response devices, are preferably aligned with the knock-out hole in the shell 44 through which the interrogating component is activated when the liner assembly is positioned on the shell 44. The knockout holes are provided separate to the mounting holes for fastening the liner to the shell. Therefore, the activation of the sensor and the transmission of the interrogating waves will be both structurally and functionally separate from the fastening devices to secure the liner 20 to the shell 44 of the mill.

The afore mentioned embodiments are of a type where the liner 20 and the sensor(s) embedded therein form a liner assembly. Components of the liner assembly are preferably preassembled, and the liner assembly may be transported on site together. In one embodiment, installation of the liner assembly with the grinder would thus involve positioning the liner assembly onto the shell 44 so that the interrogating component 31 of the liner sensor 30 will align with a knockout hole 42. Fasteners are then mounted through mounting holes in the shell 44 to engage the liner assembly and fasten it to the shell 44. An antenna, which may be provided in an insert with an external thread, may be provided through the knockout hole 42, to provide the activation signal to activate one or more sensors in the liner, such as a wear sensing arrangement or a vibration sensor, or both, embedded in the liner 20. The antenna may also be used to transmit data from the sensor(s). Or, another information transmitter (which could also be an antenna) may be included to transmit the sensor data.

Preferably, the liner assembly will also include, embedded in the liner, a power source, a controller, or both, for the sensors included in the liner 20. This way, the liner assembly will already include the arrangement required to switch on the operation of the sensors, and to energise active sensor elements, if any, included in the liner 20.

It will be appreciated that the above-mentioned advantage may realised whether there are any active sensor elements, and whether the active sensor elements included in an interrogation sensor component, in a responsive sensor component, or both. The sensors included in the liner assembly need not be restricted to be of a particular type. For instance, the senor or sensors may include wear sensing arrangements, vibration sensors, or other types of sensing arrangements. The above embodiments include both wear sensing arrangements and vibration sensing sensors are example of liner assemblies that may be provided.

In the embodiment shown in FIG. 6, the liner sensor 30 is embedded to the extent that the sensor components including the wear sensor 32 and the electronics (contained in the housing) are fully encapsulated within the liner 20. The plug 40 closes the cavity 14 in which the sensor componentry is located and in this sense the componentry is encapsulated. However, in other embodiments and in a variant from the embodiment shown in FIG. 6, the sensor componentry may be “embedded” in the liner 20 such that they are located within the envelope of the liner 20 ― that is, there may not be a plug or other closure to close the cavity.

In all embodiments, where applicable, components which are to be coupled with the actual sensing components or sensing elements may also be embedded in the liner in the manners mentioned above. For instance, a power arrangement, control arrangement, or both, or a combined power and control arrangement, to activate or control the sensor components, may also be embedded. Other components which may be embedded may include data transmission components or wireless power transmission components to supply power required by the sensor componentry. The embedding enables the liner assembly, with the componentry required for wear sensing or other sensing operation, to be a combined unit which can be transported together. Control and powering componentry may also be embedded and transported together in this manner.

In particular preferred embodiments, by fully encapsulating the componentry or positioning the componentry within the envelope of the liner, transportation of the assembled liner can be achieved using existing transport arrangements. It would not be necessary to make provisions for extra space that would be required by the sensor componentry or componentry coupled thereto, or to consider the issue of separately protecting or stabilising the componentry.

FIG. 7 illustrates a fastener 60 according to an embodiment. The fastener 60 incorporates a liner sensor and is used in place of the fasteners 26 described above and illustrated in FIGS. 1 and 2. The fastener 60 comprises a shank 46 having a threaded portion 48. A cavity formed in the central border of the shank 46 accommodates the wear sensor 32'. A housing 50 is attached to the shank 46.

In alternative embodiments, the housing may be attached to the shank by a connector. The connector may be formed from rubber. In alternate embodiments other, flexible, preferably waterproof, material may be used.

During installation, the shank 46 may be installed first and this acts as a connector, connecting the liner to the shell. Once the shank 46 is installed, the housing 50 is connected to the shank incorporating an electrical connector so that the wear sensor 32' is connected to the electronics located within the housing 50.

The housing 50 accommodates electronics package 52 (not visible in FIG. 7) which includes the vibration sensor and wireless transmitter as well as an antenna. As distinct to the arrangement of FIGS. 5 and 6, the housing 50 containing vibration sensor is not encased, disposed or embedded within the liner but when installed, is disposed in related proximity to the liner and connected thereto by virtue of the bolt shaft 48. Although not shown in the embodiment illustrated in FIG. 7, the connector may be included in an alternative arrangement to provide some damping which may potentially isolate some of the sensor vibration and may also pick up vibration which is being referred through the mill wall 44. Nonetheless, the design of the bolt allows an integrated sensor assembly that may measure both wear and vibration.

In addition to the vibration sensor, the electronics package 52 may comprise a battery, a battery sensor for determining a charge level of the battery, a temperature sensor and electronics necessary to read the wear sensor to which it is attached.

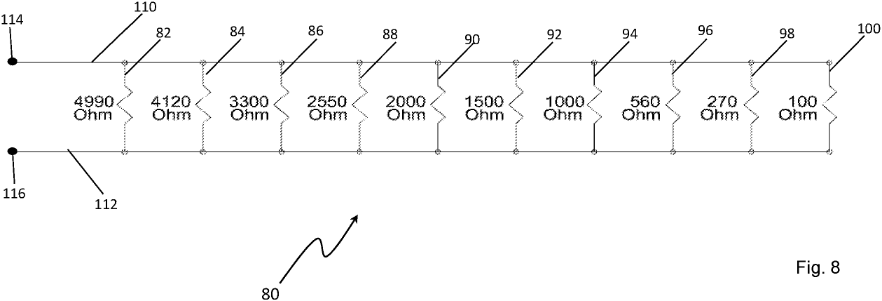

FIG. 8 illustrates a circuit diagram 80 suitable as a wear sensor for use with embodiments. The circuit 80 comprises electrical resistors 82, 84, 86, ..., 100 of different resistances, as indicated in FIG. 8.

The resistors are electrically connected in parallel across two conductors respectively indicated by the numerals 110 and 112 that run along the elongate body. The conductors 110, 112 are terminated at contacts 114 and 116 which are connected to the electronics package 52, for example, with reference to the embodiment of FIG. 7.

The length of the electronic structure depends on the thickness of the wear part to be monitored. Typically, the length is in the range of 5 mm to 200 mm although other lengths are appropriate in some circumstances. In the embodiments illustrated, the wear sensor comprises a printed circuit board which is 3 mm wide and 1 mm thick but other embodiments have smaller or larger values.

In another embodiment, resistors are mounted on both sides of the circuit board. The resistors on one side of the board may be offset with respect to the resistors on the other side of the circuit board (an array on one side staggered with respect to an array on the other side). Consequently, the depth resolution of the sensor may be greater than the case when components are only mounted to one side of the circuit board for a given length of circuit board.

Each resistor has a respective component value (i.e. resistance) such that the measured value of that electrical characteristic increases in substantially equal steps as the components are sequentially worn away. Any number of resistors ― more or less than the ten shown - may be used in which case the resistor values shown in FIG. 8 may be altered. The more resistors used the better the wear depth accuracy of the wear sensor. The following algorithm may be used to calculate the values for an arbitrary number of resistors within the wear sensor such that the measured value of resistance increases in substantially equal steps.

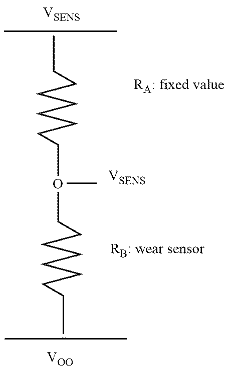

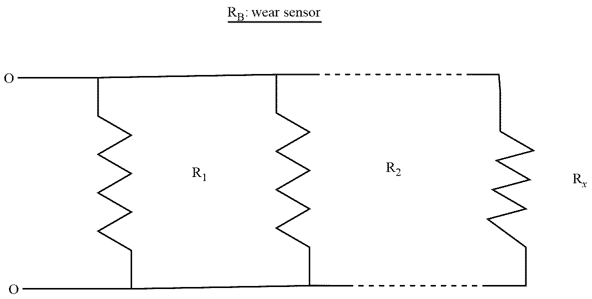

$${V}_{S E N S} = {V}_{\text{DD}} ⋅ \frac{{\text{R}}_{\text{B}}}{{\text{R}}_{\text{A}} {\text{+R}}_{\text{B}}}$$

$${R}_{B} = {V}_{\text{SENS}} ⋅ \frac{{\text{R}}_{\text{A}}}{{\text{V}}_{\text{DD}} {\text{-V}}_{\text{SENS}}}$$

$${R}_{B} = \frac{1}{\frac{1}{{\text{R}}_{1}} + \frac{1}{{\text{R}}_{2}} + ⋯ + \frac{1}{{\text{R}}_{\text{x}}}}$$

The number of and individual resistance values of the resistors may be calculated as follows:
1. Choose R_{A} value (determines power consumption).
2. Choose desired resolution (i.e. number of resistors in the wear sensor device).
3. Calculate V_{SENS} values at each resistor location (“step”) using V_{DD} and number of resistors.
4. For all V_{SENS} values calculate RB using Eqn. (2).
5. For each resistor/step and R_{B} value calculate R₁→Rₓ using Eqn. (3).

It is to be realised that capacitors or inductors could be used instead of resistors.

Further examples of suitable wear detectors for use with embodiments of the invention are described in WO2012122587, the contents of which are incorporated herein by reference.

As alluded to above, the wear sensor, or more specifically, the wear part of the wear sensing arrangement, is not limited to having the above arrangement. For instance, the wear part may simply be a wear probe which is coupled with at least one ultrasonic transducer, which may be a piezoelectric or electro-magnetic acoustic transducer. In other examples, the wear part may comprise non-resistive electrical devices. Alternatively, other types of devices, such as dielectric, optical, semiconducting devices may be used to form the sacrificial wear part sensor, intended to respond to other types of interrogating signals than an electric current.

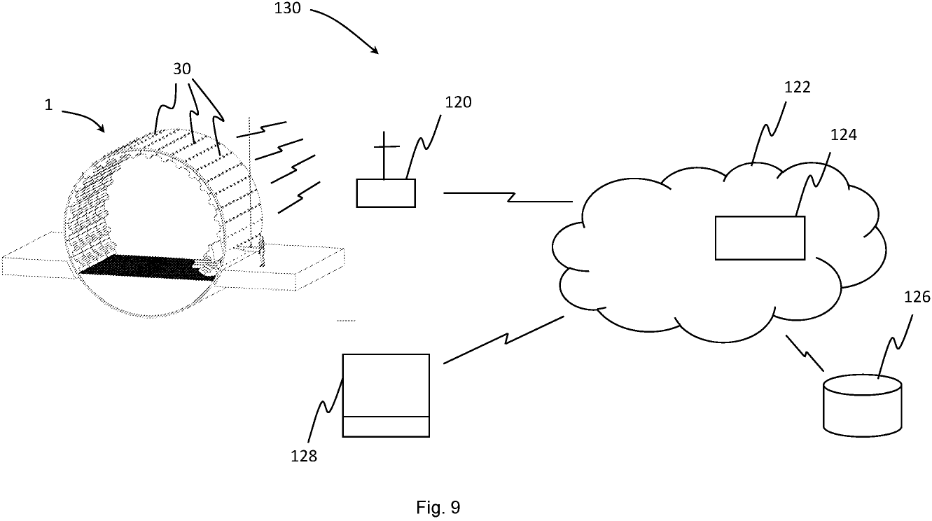

FIG. 9 illustrates a system 130 for carrying out a method of monitoring a grinding mill according to an embodiment. The system 130 comprises a grinding mill 1 having a plurality of liner sensors 30 installed therein. The liner sensors 30 may be provided by way of one or more mill liners or mill liner assemblies discussed in this document. Each of the liner sensors communicates wirelessly with a base station 120. In this embodiment the wireless communication occurs via LTE. In an alternative embodiment LoRa may be used instead. LTE and LoRa have the advantage of being able to transmit signals despite the significant interference which may be caused by the metal components of the grinding mill 1.

The base station 120 communicates with a processor 124 which, in this embodiment, is located within a computing cloud 122. In alternate embodiments the processor 124 may be provided as a dedicated server which may be connected via a wired or wireless network. The processor 124 communicates with data storage 126 and with a user workstation 128.

The user workstation 128, processor 124 and data storage 126 cooperate through known client/server arrangements to provide the functionality herein described.

Data pertaining to the vibration and wear of the liners of the mill 1 is generated by the liner sensors 30, collected by the base station 120 and written to the storage 126 by the processor 124. The sensor may be operable continuously to transmit data or at pre-set or user selectable intervals as required

Each of the liner sensors 30 will have a unique identifier associated therewith. During an initial set up phase, a record is stored in the data store 126 correlating the identification number with a position for the corresponding liner sensor. In this manner embodiments are able to correlate the sense vibration and wear with the particular location.

In the embodiment illustrated, mill 1 further includes an angle sensor which senses the rotational position of the mill. This information is also transmitted to the base station 120 and, via the processor 124, stored in the storage 126. By collating the changing angle over time, the processor 124 is able to calculate the rotational speed of the mill drum.

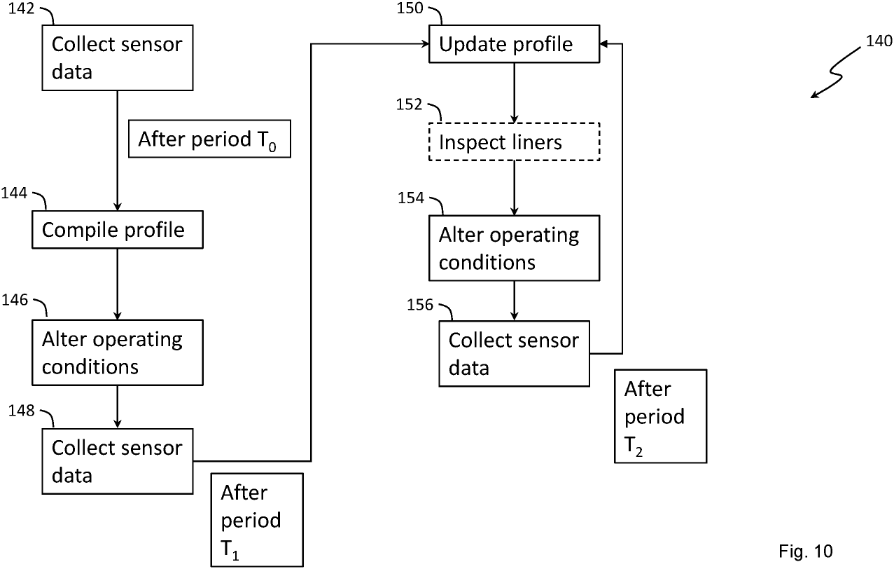

FIG. 10 illustrates a method 140 of monitoring a grinding mill according to an embodiment. At an initial step 142 the sensor data is collected as described above with reference to FIG. 9. At step 144 a profile of the grinding mill 1 is compiled. It is to be realised that the profile may depend on the characteristics of the particular grinding mill. In an embodiment, the profile includes vibration correlated with wear for a number of positions.

At the following step, step 146, the operating conditions of the mill 1 are altered. Again, this may depend on the particular operating conditions of the mill concerned. In an embodiment this includes altering one or more of: a size of the charge; aggregate particle size; rotational speed of the drum etc.

At the following step, step 148, the sensor data is collected for the altered operating conditions and the mill profile is updated at step 150. By comparing the initial profile with the updated profile, a user is able to determine whether the changes made to the operating conditions have had a positive effect on the running of the mill. For example, if the changes to the operating conditions have reduced the wear on the liners, this will be reflected in the wear data obtained from the sensors and recorded in the updated profile.

At an optional further step 152 a user may inspect the liners to correlate the sensor information with a visual inspection. Then at steps 154 and 156, the operating editions are altered, and sensor data is again collected for the altered operating conditions. If desired, the process may then return to step 150 so that steps 153 to 156 form a loop whereby a user is able to update operating conditions and determine whether those updated conditions have a positive and negative effect on the operation of the mill by updating the mill profile.

In the claims which follow and in the preceding description, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments. Similarly, the word “device” is used in a broad sense and is intended to cover the constituent parts provided as an integral whole as well as an instantiation where one or more of the constituent parts are provided separate to one another.

1-49. (canceled)

50. A mill liner assembly for a grinding mill, comprising:
a mill liner which comprises a wear surface and an opposite inner surface that is arranged in use to be mounted in opposed relation to an interior surface of a shell of the grinding mill,
a liner sensor which is embedded within the mill liner; and
a control and/or power arrangement configured to control and/or power the liner sensor, the control or power arrangement being also embedded in the mill liner;
wherein the liner sensor and the control and/or power arrangement are embedded so that they are positioned within an envelope of the mill liner.

51. The mill liner assembly of claim 50, wherein the control and/or power arrangement is fully encapsulated in the mill liner.

52. The mill liner assembly of claim 50, wherein, in use, the control and/or power arrangement is activatable from an inner surface of the mill liner accessible via an aperture in a shell of the grinding mill.

53. A mill liner assembly for a grinding mill, comprising:
a mill liner which comprises a wear surface and an opposite inner surface that is arranged in use to be mounted in opposed relation to an interior surface of a shell of the grinding mill;
a liner sensor which is embedded within the mill liner; and
a control and/or power arrangement configured to control and/or power the liner sensor, the control and/or power arrangement being also embedded in the mill liner;
wherein, in use, the control and/or power arrangement is activatable from an inner surface of the mill liner accessible via an aperture in a shell of the grinding mill.

54. The mill liner assembly of claim 52, wherein the aperture is separate from a mounting aperture provided for receiving a fastener to fasten the mill liner assembly to the grinding mill.

55. The mill liner assembly of claim 50, wherein the liner sensor includes a wear sensing arrangement configured to measure wear in the wear surface, a vibration sensor configured to sense vibration of the mill liner in use in the grinding mill, or both.

56. The mill liner assembly of claim 50, wherein the liner sensor comprises at least one active sensor component.

57. The mill liner assembly of claim 56, wherein the at least one active sensor component is or is part of an interrogator component configured to provide an interrogation signal.

58. The mill liner assembly of claim 57, wherein the mill liner or a responsive component embedded in the mill liner is adapted to interact with the interrogation signal to generate a response signal.

59. The mill liner assembly of claim 56, wherein the at least one active sensor component is or is part of a responsive component configured to interact with an interrogation signal and provide a response signal.

60. The mill liner assembly of claim 50, wherein the power or control arrangement is located in a cavity formed in the mill liner, or located in a plug adapted to substantially seal the cavity.

61. The mill liner assembly according to claim 57, wherein a response signal acquired in response to the interrogation signal provides two-dimensional data in relation to the wear surface.

62. The mill liner assembly according to claim 58, wherein the responsive component wears together with the mill liner.

63. The mill liner assembly according to claim 58, wherein the responsive component comprises one of: a ladder resistor, an ultrasonic probe, sacrificial dielectric or optical components.

64. The mill liner assembly according to claim 50, wherein information relating to sensed vibration and/or wear of the mill liner is configured to be transmitted to a location remote from the mill via a means to transmit information.

65. The mill liner assembly according to claim 64 wherein the means to transmit information comprises an antenna, wherein the antenna is attachable to the wear sensing arrangement through the opposed inner surface of the liner.

66. The mill liner assembly according to claim 64, wherein the means to transmit information is a transceiver device.

67. The mill liner assembly according to claim 64, wherein the means to transmit information is provided in an aperture provided in the shell of the grinding mill.

68. The mill liner assembly according to claim 66, wherein the transceiver device is in use configured to provide an activation signal to the liner sensor.

69. The mill liner assembly according to claim 50, wherein the liner sensor is disposed in a void formed in the mill liner.

70. The mill liner assembly of claim 50, wherein the liner sensor further comprises a thermometer and/or a battery capacity metre.

71. The mill liner assembly of claim 50, further comprising a wireless communication module.

72. A grinding mill comprising a shell and one or a plurality of the mill liner assembly in accordance with claim 50.

73. A method of transporting a mill liner assembly for a grinding mill, the method comprising:
providing a mill liner assembly in accordance with claim 50; and
transporting the mill liner assembly with the liner sensor embedded therein as an integrated assembly, with the miller liner protecting the embedded sensor during transport.

74. A method of controlling and/or powering a mill liner assembly for a grinding mill in accordance with claim 50, the method comprising:
mounting the miller liner assembly to the grinding mill, such that the inner surface of the mill liner is in opposed relation to an interior surface of a shell of the grinding mill;
providing an activation signal via an aperture in the shell of the grinding mill, to activate the control and/or power arrangement embedded within the mill liner.
